(19) United States
(12) Patent Application Publication
(10) Pub. No.: US 2015/0314410 A1
(43) Pub. Date: Nov. 5, 2015

(54) TOOL, MACHINING METHOD

(71) Applicant: SAUER ULTRASONIC GMBH, Stipshausen (DE)

(72) Inventor: Florian Feucht, Hüttlingen (DE)

(73) Assignee: Sauer Ultrasonic GmbH, Stipshausen (DE)

(21) Appl. No.: 14/650,199

(22) PCT Filed: Dec. 5, 2013
(86) PCT No.: PCT/EP2013/075663

§ 371 Date: Jun. 5, 2015

(30) Foreign Application Priority Data
Dec. 5, 2012 (DE) 10 2012 222 360.6

(51) Int. Cl. B23Q 11/00; B23B 29/12; B23Q 1/00

(52) U.S. Cl. CPC B23Q 11/0046; B23Q 1/0009; B23B 29/125; B23B 2260/108

(57) ABSTRACT

A tool (10) for machining a workpiece in a machine tool comprises a coupling portion (41) that is in operation on the machine-side and that may be standardized for coupling the tool with a numerically controlled machine tool (30), a tool portion (43) that is in operation on the workpiece-side for machining the workpiece, and a mid-portion (42) between the coupling portion (41) and the tool portion (43). The tool portion (43) comprises on the workpiece-side one or more suction air openings (15) in communication with suction air channel (16) inside the tool that leads to the mid-portion (42) of the tool. In the middle portion a connector (11) for a suction air connector (38, 39) is provided that is displaced. sideways relative to the tool axis.

The invention relates to a tool, a machine tool and a machining method for workpieces according to the preamble of claim 1.

When workpieces are machined with tools with or without defined cutting edge, chips and dust appear. Dust is problematic because it distributes in uncontrolled manner and may adhere to and accumulate at the tool or at machine components, this compromising effectiveness and precision of the tool. Besides, dust may be a health hazard.

It is known to provide large-scale suction devices, that try to catch dust in the vicinity of workpieces similar to a vacuum cleaner. This is effective to some extent, but not fully. The suction device (opening) is usually stationary. Thus, in operation of multi-axis machine tools, machine components may cover the suction means or degrade its effectiveness. Particularly at the tool itself suction is insufficient so that above all the problem of dust adhering and depositing at the tool is not solved.

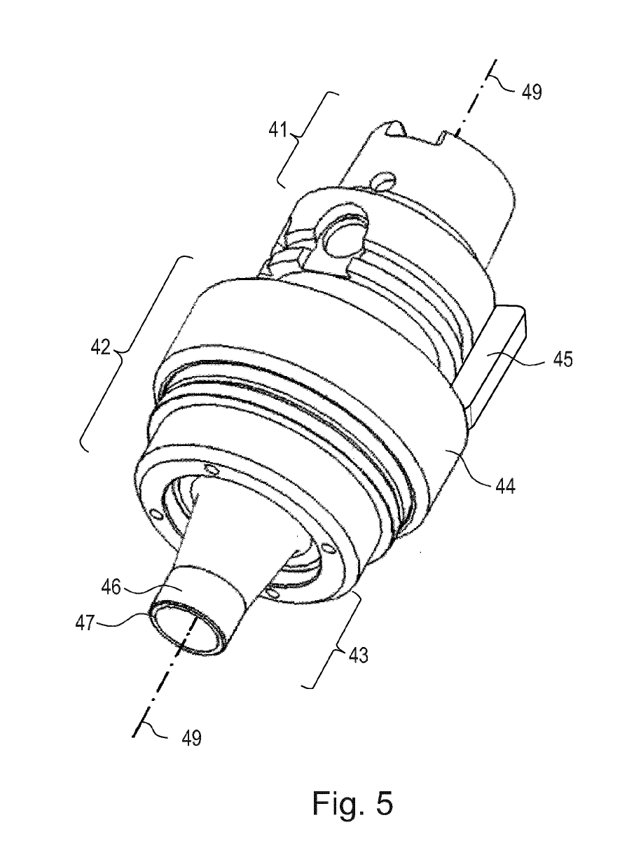

FIG. 5 shows a known conventional tool. It comprises a coupling portion 41 towards the machine tool 30. Usually, the coupling portion is standardized. (HSK, tool taper, . . . ). The tool comprises also a tool portion 43, which is made for machining the workpiece. FIG. 5 shows as an example a drill with a grinding drill area 47 and rearward thereof a cylindrical portion 46. The whole tool is turnable around axis 49. A vibrating motion may be superimposed on the turning work movement. The vibration may be a translatory vibration parallel to the tool axis 49. In the middle portion 42 of the tool a vibration drive may be provided for this, it may comprise a piezo actor.

The drive may inductively be supplied with power. The tool comprises for this a ring-shaped induction coil 44, that encompasses the tool or at least its turning axis 49 and that turns in operation together with the tool. A “send”-coil 45 is provided stationary. It is stationary and not part of the tool, but fixedly connected to the machine tool and does not turn when the tool is in operation. It generates an alternating magnetic field that floods coil 44 and causes induced currents there which may, inside the tool, be shaped and used.

Both in chipping and grinding drilling with or without superimposed vibration dust is generated in significant amounts. To a certain extent it is so fine that is does not sink downward following gravity, but remains, due to convection, in the atmosphere and distributes.

Attempts were made towards a coaxial suction air flow through the tool using the internal cooling fluid duct of a tool of a machine tool. Qualitatively this works. But quantitatively the suction power is insufficient because the axial opening of the cooling fluid passage is relatively small so that an effective suction air flows cannot be generated. And further, it is disadvantageous that the sucked-in dust passes the entire tool length and channels within the spindle and thus adheres in the interior of the tool and the channels of the spindle.

It is the object of the invention to provide a tool for operating a workpiece, a machine tool and an operation method having good dust removal characteristics.

This object is accomplished by the features of the independent claims. Independent claims are directed on preferred embodiments of the invention.

A tool for operating a workpiece in a machine tool comprises in its tool portion one or more workpiece-side suction air openings which communicate with one or more suction air channels inside the tool portion. Further, a suction air connector is provided sideways of the tool axis.

The tool may comprise a ring chamber that encompasses the tool ring-like and that is in fluid connection with the suction air channel and which comprises a ring-shaped turnable wall at which the connector is provided.

Since in this way a connector for suction air is made that is disposed sideways of the tool axis, one is not restricted to using the narrow geometry inside the coupling part of the tool towards the machine. The suction air connector may thus have a relatively high diameter and thus allows high volume rates.

When the tool turns during workpiece machining, the ring chamber having the turnable wall carrying the connector allows turning the tool while having a stationary connector for the suction air at the same time.

The tool may comprise a vibration drive for the tool portion. It may comprise a piezo-actor in the middle portion of the tool. For this, a power supply may be used that receives power inductively and which comprises an induction coil that surrounds the tool and which, compared to the ring chamber, is radially outward or axially displaced towards the workpiece.

A machine tool has a mechanical connector for a tool as described above or in the following and a suction air connector for the tool that is provided eccentric relative to the spindle.

The machine-tool-side suction air connector is in fluid connection with a suction device. It may be an air pump provided at a suitable location. Further, a filter may be provided at a suitable location for filtering dust out of the sucked air.

The machine tool may hold the mentioned tool as usual in a tool magazine of the machine tool. When coupling the tool with the machine tool, particular coupling steps for the suction air circuit may be made, or the design is such that the suction air coupling between machine tool and tool is made together with the mechanical coupling of the tool towards the machine tool

In a machining method for a workpiece with a tool in a numerically controlled machine tool the workpiece is machined for example by drilling or milling or only by vibration of the tool according to a machining program. During machining the workpiece or afterward, air carrying dust from the machining site is guided via suction air channels in the tool portion of the tool through the front part of the tool and is guided sideways out of the tool.

In this way, dust-loaded air is vacuumed immediately at the site of generation by a relatively strong volume flow so that is does not reach the wider cabin space of the machine tool. And since it is guided sideways out of the tool not the entire tool interior is exposed to the dust-loaded air.

In the following, embodiments of the invention are described with reference to the figures. They show:

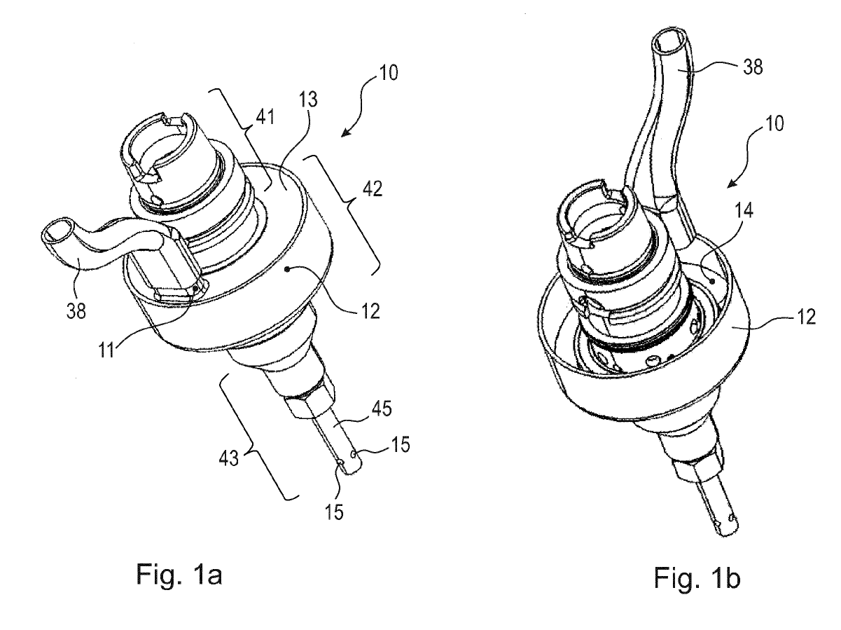

FIG. 1: different views of a tool according to the invention,

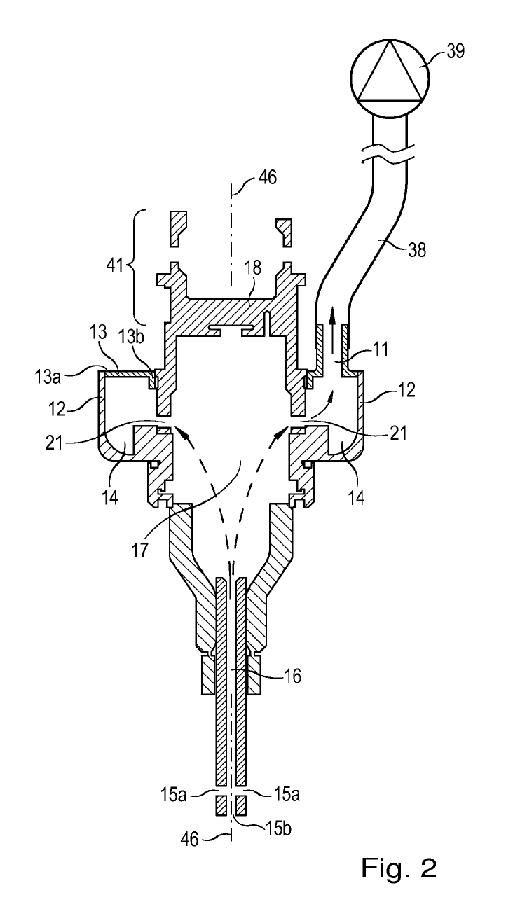

FIG. 2: a sectional view of an embodiment,

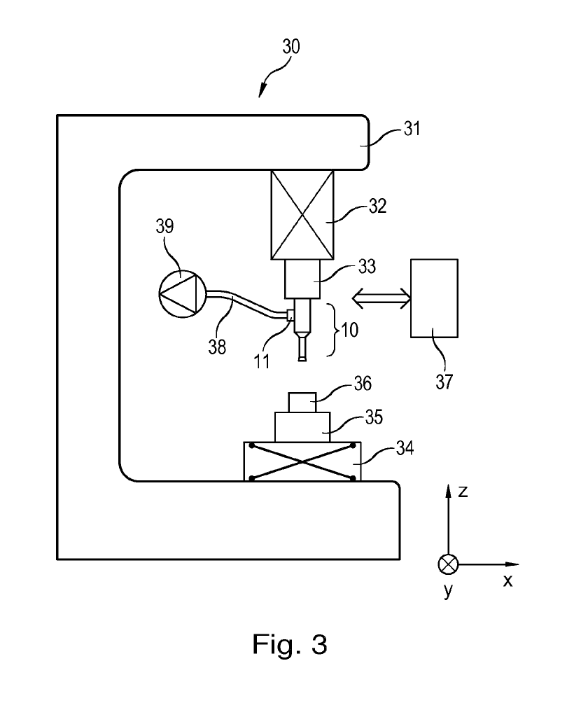

FIG. 3: schematically a machine tool,

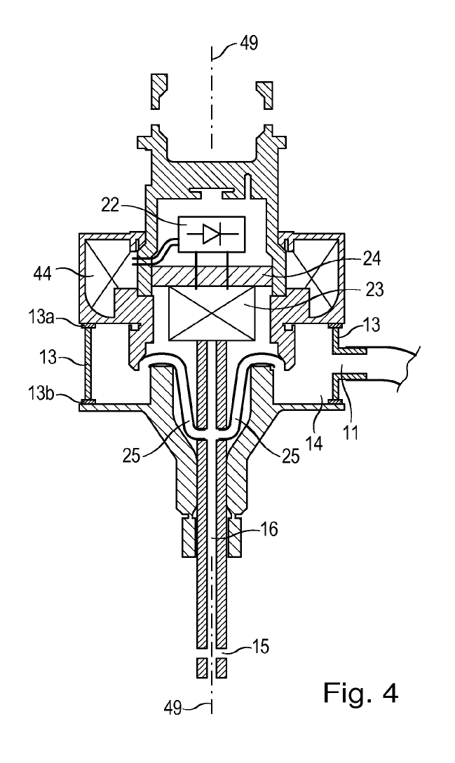

FIG. 4: schematically a sectional view of a further embodiment, and

FIG. 5: a known tool.

Generally, same reference numerals in this specification shall designate same components. Features of the invention shall be deemed combinable with each other also if this is not expressly said, as far as the combination is technically possible, also as far as features are concerned belonging to the prior art (FIG. 5). Description of device features shall be understood also as description of methods and method steps implemented by the respective device feature, and vice-versa.

FIG. 1a shows perspectively a possible construction of a tool 10 in closed state, whereas FIG. 1b shows it—from another perspective—in an open state. In the example of FIG. 1a and 1b it is assumed that the tool itself does not vibrate and thus no vibration drive and no (inductive) power supply is required.

45 symbolizes the actual tool portion which in FIGS. 1a and 1b would machine a workpiece by its lower right portion. The tool portion 45 has at its workpiece-sided end and/or sideways one or more suction air openings 15. FIG. 2 shows an axial face-side suction air opening 15b and two sideways suction air openings 15a. These openings 15 are in fluid communication with a suction air channel 16 inside the tool portion.

Further, the tool comprises a connector 11. It is displaced sideways with respect to the turning axis 49 of the tool. Particularly, the suction air is not sucked through the concentric opening of the cooling fluid supply. Thus, a relatively large suction air cross section may be formed, so that effective volume flows can be generated. The diameter of channel 11 may be larger than the diameter of cross sections of the suction air openings 45. It may be larger than 0.5 or 1 or 2 cm². It may be smaller than 5 or 3 cm².

The suction air connector 11 of the tool 10 is in fluid connection with suction air channel 16 inside the tool portion 43, so that through this suction air channel 16 and the connector 11 a fluid connection is formed directly from the machining site at the workpiece towards a machine-side suction air source. This is symbolized by 38, 39 in FIG. 1 and is shown in FIG. 1 as connected to the tool. 38 is already a machine-side duct which is provided more or less stationary in the machine tool. It may be a fixed stud or a more or less movable pipe which may continue rearward as rigid duct or as pipe duct according to necessities, and may reach outside of and beyond the machine tool housing. In FIGS. 1a and 1b the connector of duct 38 is shown as coupled with connector 11 of the tool. But 38 is not part of the tool as it is stored in the tool magazine.

The coupling portion 41 of the tool towards the machine 30 may be formed according to a standard, such as a HSK-coupling in one of the rated diameters, as a tool taper or the like. The machine tool comprises a corresponding complementary mechanical coupling.

As also shown in FIG. 2 schematically, 38 is a duct that is plugged onto the terminal 11 and which is in fluid communication with a suction air source 39. Not shown is a dust filter that may be provided at a suitable portion of the machine-side fluid duct. The filter may be remote from the tool and may be outside the machine tool housing. It may be provided in an explosion-protected housing.

FIG. 2 shows an embodiment in which the dust carrying fluid sucked through opening 15 from the machining site reaches through channel 16 into the tool 10 and from there to connector 11. This is indicated by the dashed arrow. In the mounting portion 41 of the tool toward the machine usually a passage is provided which allows for example the supply of cooling fluid. In the described tool it may not be provided or it may be closed by a closing 18 for preventing dust from reaching from the interior of the tool into the spindle.

FIGS. 1a, 1b and 2 show embodiments in which the suction air connector 11 of the tool is formed at a tool-side ring chamber 14.

Particularly, it is formed at a turnable wall 13 of ring chamber 14. The ring chamber 14 surrounds tool 10 ring like and is particularly coaxial to the tool axis 49. It comprises not-displaceable wall portions 12 that may be fixedly connected with the tool 10, and the rotatable wall 13 which may also turn around tool axis 49 as turning axis. The ring chamber 14 is in fluid communication with the suction openings 15 and the channel 16 of the tool portion 43.

When during workpiece machining the tool 10 turns around axis 49, the turnable wall 13 and thus also the terminal 11 may be stationary or may turn relative to the tool. Thus it is ensured that the suction air source 39 that is stationary with respect to the machine tool can be connected via duct 38 to the turning tool 10. The rotatable wall 13 comprises connecting portions 13a and 13b to the wall portions 12 that are fixed (relative to tool 10) of the ring chamber. They allow the relative turning of wall 13 with respect to the stationary wall parts 12 such that gas tightness is sufficiently ensured. As far as wear is to be expected, the construction may be such that exchangeable wearing parts 13a and 13b are provided in the transition portion.

The ring chamber 14 may communicate through plural channels 21, together having a sufficient suction air cross section, with the interior 17 of tool 10 such that the fluid connection towards the tool portion 43 is ensured.

FIG. 3 shows schematically a machine tool 30. 31 is a more or less rigid machine frame. 32 symbolizes several actuators that allow the translational or rotational displacement and adjustment of tool 10. 33 symbolizes a spindle that may turn the tool 10. Tool 10 is formed as described above and in the following. 34 symbolizes actuators for a workpiece table 35 which may adjust the workpiece table 35 translatory or rotational. 36 is the workpiece itself.

37 symbolizes a controller or feedback-controller which, on the one hand side, sends signals towards the process, particularly towards the various actuators 32, 34, and if necessary also to the tool 10 itself and if necessary also to other, not shown components. Further, it may also receive signals, particularly signals fed -back from sensors not shown in FIG. 3, among them possibly also sensors within the tool. The control 37 operates in accordance with a program for machining a workpiece 36. Between tool 10 and spindle 33 is the standardized tool coupling structure (HSK, tool taper . . . ) which are at tool 10 in its mounting portion 41.

The machine 30 comprises the suction air source symbolized by 39. It may be a suction air pump that may be driven electrically and which may be controlled or feedback-controlled by controller 37. It is connected or connectable with tool 10 via duct 38 which is stationary with respect to machine 30, wherein the duct 38 may be plugged onto the connector 11 or is otherwise suitably connected.

Not shown is a tool magazine that holds tool 10 and possibly other tools when they are not required, and a tool change mechanism that automatically makes the tool change between spindle 33 and magazine, also controlled by controller 37. The overall design may be such that the tool change mechanism makes during mounting or dismounting of tool 10 at or from the machine tool the usual known steps for establishing or resolving the mechanical coupling between tool and machine tool. Concurrently thereto or before that or afterwards also the connection between duct 38 and connector 11 may automatically be made, for example by additional steps of the tool change mechanism.

The design may be such that by a common relative movement between tool 10 and machine tool 30 both the mechanical coupling as well as the suction air connection are established or separated. But also other designs are possible, for example the tool changer making additional movements or steps for establishing or separating the fluid connection besides the mechanical coupling.

FIG. 4 shows an alternative embodiment of tool 10 schematically. Here it is assumed that the tool portion itself is driven vibratingly and a vibration drive 23 is provided for this that vibrates at least the tool portion 43 and possibly the lower part of the middle portion 42 of the tool relative to the other parts of tool 10. The vibration may be a translatory vibration parallel to axis 49. It may have a vibration frequency of more than 500 Hertz or more than 1 Kilohertz and may be below 3 Kilohertz. But it may also be much higher, for example higher than 10 Kilohertz or higher than 20 Kilohertz. For this, a vibration drive 23 is provided that has a mount 24 internally in tool 10.

The vibration drive is driven preferably electrically. It may be a piezo drive. For power supply a wireless power supply may be provided, particularly a coil 44 surrounding the tool coaxial to axis 49. In operation it is flooded by a magnetic alternating field generated by a stationary coil 45 (FIG. 5) facing the ring coil 44 with low distance in between. AC is induced at the terminals of ring coil 44 that may be supplied to a voltage forming circuit 22 that may generate suitable driving voltages for the vibration drive 23.

Also here a connector 11 for suction air is provided. The connector may again be provided at displaceable wall 13 of ring chamber 14. The ring chamber 14 may, as shown in FIG. 4, be axially displaced towards the tool portion 43 with respect to the ring coil 44 and may be adjacent to it. But it may also be radially outward of ring coil 44. FIG. 4 shows further an embodiment in which the rotatable wall 14 is not provided in a plane vertical to the tool axis 49, but in a cylindrical wall concentric to tool axis 49.

Further, FIG. 4 shows an embodiment in which the suction air does not flow through the inner space 17 of the tool, but in which ducts 25 are provided that connect channel 16 in the tool portion 43 with connector 11, particularly as shown in FIG. 4 via the ring chamber 14.

1. Tool for machining a workpiece in a machine tool, comprising:
a coupling portion that is in operation on the machine-side and that may be standardized, for coupling the tool with a numerically controlled machine tool,
a tool portion that is in operation on the workpiece-side, for machining the workpiece, and
a mid-portion between the coupling portion and the tool portion,
characterized in that the tool portion comprises on the workpiece-side one or more suction air openings in communication with a suction air channel inside the tool, and in the middle portion a connector for a suction air connector is provided, the connector being displaced sideways relative to the tool axis.

2. Tool according to claim 1 in which the connector is in fluid communication with the interior of the middle portion.

3. Tool according to claim 1, further comprising a ring chamber that surrounds the tool, preferably its middle portion, in a ring-like manner, wherein the ring chamber is in fluid connection with a suction air channel of the tool portion and has a ring shaped rotatably shiftable wall carrying the connector.

4. Tool according to claim 3 in which the rotatably shiftable wall is connected to a stationary wall of the ring chamber by exchangeable wear parts.

5. Tool according to claim 3 in which the rotatably shiftable wall is in a plane vertical to the tool axis and preferably faces the machine.

6. Tool according to claim 3 in which the rotatably shiftable wall is a cylindrical surface coaxial to the tool axis.

7. Tool according to claim 3 in which the ring chamber has one or more fluid connections to the interior of the middle portion that communicates with the suction air channel of the tool portion.

8. Tool according to claim 3 in which the ring chamber is connected with one or more fluid ducts that communicate with the suction air channel of the tool portion.

9. Tool according to claim 1, characterized in that the end portion of the connector extends in parallel to axis.

10. Tool according to claim 9, in which the free end of the connector points away from the workpiece and can be plugged onto a suction air connector and is designed such that the suction air connection can be established jointly with inserting the tool into the machine tool.

11. Tool according to claim 1, characterized by a vibration drive for the tool portion, preferably comprising a piezo drive in the mid portion of the tool.

12. Tool according to claim 3, comprising a power supply that receives power inductively and that comprises a ring coil surrounding the tool and that is displaced with respect to the ring chamber radially outward or axially towards the workpiece.

13. Tool according to claim 1, comprising a closure of an axial opening of a medium supply in the coupling portion.

14. A machine tool comprising a mechanical coupling for a tool according to claim 1, and a suction air connector for the tool.

15. Machining method for a workpiece by a tool in a numerically controlled machine tool, in which the tool machines the workpiece following a program preferably by milling or drilling or vibratingly and in which during workpiece machining or afterwards air including dust is sucked via a suction air channel in the tool portion of the tool through the tool and is guided sideways out of the tool.
